(19) United States
(12) Patent Application Publication
(10) Pub. No.: US 2026/0367760 A1
(43) Pub. Date: Nov. 19, 2026

(54) AI-POWERED TAB CONTROLLER FOR APPLICATIONS DISPLAYED IN SCREEN SHARING SESSIONS

(71) Applicant: MICROSOFT TECHNOLOGY LICENSING, LLC, Redmond, WA (US)

(72) Inventor: Mrinal Kumar SHARMA, Noida (IN)

(21) Appl. No.: 19/212,130

(22) Filed: May 19, 2025

(51) Int. Cl. G06F 3/0483; G06F 3/0482; G06F 3/14; G06F 40/279; G06F 40/40

(52) U.S. Cl. CPC G06F 3/0483; G06F 3/0482; G06F 3/1454; G06F 40/279; G06F 40/40

(57) ABSTRACT

The techniques disclosed herein disclosed herein provide an AI-powered Smart Screen Share Director. The AI-powered Smart Screen Share Director enables systems to automatically select and share screens in virtual meetings by intelligently identifying the most relevant tab or window based on the meeting's context, live text speeches and ongoing discussions and preventing accidental sharing of unrelated or sensitive content. In some embodiments, the system provides a list of tab candidates that are ranked based on a relevancy with activity of a meeting. This guides a presenter to context-aware tabs in a timely manner. In some embodiments, the system automatically selects a tab selection.

### BACKGROUND

In enterprise environments, professionals such as engineers, designers, and product managers often work across multiple browser tabs and applications, including Figma for design work, PowerPoint for presentations, Loop for project tracking, and Word for documentation. When joining meetings, users frequently need to share their screens but struggle to determine which tab is most relevant. This can lead to delays, unintentional sharing of irrelevant or personal content, and a disrupted workflow.

Current screen-sharing mechanisms only allow users to select from a list of open tabs without any contextual intelligence. There is no system in place that dynamically analyzes the meeting context, understands relevant content, and prevents accidental sharing of irrelevant or sensitive information.

As professionals handle multiple browser tabs and applications, selecting the correct tab for screen sharing becomes cumbersome. Users often waste time searching for the correct document, or worse, accidentally share personal or irrelevant tabs, leading to unprofessional or even security-compromising situations.

### SUMMARY

The techniques disclosed herein disclosed herein provide an AI-powered Smart Screen Share Director. The AI-powered Smart Screen Share Director enables systems to automatically select and share screens in virtual meetings by intelligently identifying the most relevant tab or window based on the meeting's context, live text speeches and ongoing discussions and preventing accidental sharing of unrelated or sensitive content. In some embodiments, the system provides a list of tab candidates that are ranked based on a relevancy with activity of a meeting. This guides a presenter to context-aware tabs in a timely manner. In some embodiments, the system automatically selects a tab selection. The selected tab is based on the relevancy of the tab with activity of the meeting. For each embodiment, an AI agent continuously analyzes the meeting title, agenda, and live discussion topics to predict and suggest the most relevant tab or application window a user should share. Whether it's an engineer debugging in a code repository, a designer reviewing files, or a product manager presenting a strategy deck, the AI ensures the right content is highlighted for easy user selection or automatically displayed.

Some embodiments provide accidental sharing prevention. If a user unintentionally selects an irrelevant or potentially private tab, the system detects the mismatch between the shared content and the meeting context. It then alerts the user with a warning and suggests switching to the correct tab before sharing. This can also improve the security of a system by using a trained AI model to restrict the display of sensitive or private information during meetings.

Some embodiments provide multi-application awareness. Unlike existing solutions limited to a single browser, the disclosed AI agent works across multiple browsers and applications, detecting open documents, design files, dashboards, and other relevant work materials to enhance screen-sharing efficiency.

By automating tab selection and preventing mis-shares, this AI-driven solution eliminates friction, saves time, and enhances security in virtual meetings, ensuring professionals across different roles can focus on collaboration instead of manually sorting through countless open tabs.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for generating a list of ranked tab candidates based on a detected context of a meeting.

FIG. 2A shows a stage of a process for automatic display of a ranked list of tabs where the system displays a plurality of tabs in a browser

FIG. 2B shows a stage of a process for automatic display of a ranked list of tabs where the system accesses meeting content.

FIG. 2C shows a stage of a process for automatic display of a ranked list of tabs where the system accesses meeting properties.

FIG. 2D shows a stage of a process for automatic display of a ranked list of tabs where the system generates tab metadata.

FIG. 2E shows a stage of a process for automatic display of a ranked list of tabs where the system selects classifications for individual tabs.

FIG. 2F shows a stage of a process for automatic display of a ranked list of tabs where the system generates a prompt for an LLM.

FIG. 2G shows a stage of a process for automatic display of a ranked list of tabs where the system communicates the prompt to the LLM.

FIG. 2H shows a stage of a process for automatic display of a ranked list of tabs where the system utilizes ranking data from the LLM to display a ranked list of tab candidates.

FIG. 2I shows a stage of a process for automatic display of a ranked list of tabs where the system receives an input from a user from the ranked list of tab candidates.

FIG. 2J shows a stage of a process for automatic display of a ranked list of tabs where the system responds to the input to display a selected tab from the ranked list of tab candidates.

FIG. 2K shows a stage of a process for automatic display of a ranked list of tabs where the system initiates a screen share session to show the selected tab.

FIG. 3A shows a stage of a process for automatic selection of a tab where the system displays a plurality of tabs in a browser

FIG. 3B shows a stage of a process for automatic selection of a tab where the system accesses meeting content.

FIG. 3C shows a stage of a process for automatic selection of a tab where the system accesses meeting properties.

FIG. 3D shows a stage of a process for automatic selection of a tab where the system generates tab metadata.

FIG. 3E shows a stage of a process for automatic selection of a tab where the system selects classifications for individual tabs.

FIG. 3F shows a stage of a process for automatic selection of a tab where the system generates a prompt for an LLM.

FIG. 3G shows a stage of a process for automatic selection of a tab where the system communicates the prompt to the LLM.

FIG. 3H shows a stage of a process for automatic selection of a tab where the system utilizes control data from the LLM to automatically display a selected tab.

FIG. 3I shows a stage of a process for automatic selection of a tab where the system initiates a screen share session to show the selected tab.

FIG. 4 is an example assignment of classifications for each tab based on direct mapping.

FIG. 5 is an example showing how the system filters tab candidates from being on the ranked list for improving security of the system.

FIG. 6 is a flow diagram showing aspects of a routine for implementing aspects of the disclosed techniques.

FIG. 7 is a diagram illustrating a distributed computing environment capable of implementing aspects of the techniques and technologies presented herein.

FIG. 8 is a computer architecture diagram illustrating a computing device architecture for a computing device capable of implementing aspects of the techniques and technologies presented herein.

### DETAILED DESCRIPTION

As professionals handle multiple browser tabs and applications, selecting the correct tab for screen sharing becomes cumbersome. Users often waste time searching for the correct document, or worse, accidentally share personal or irrelevant tabs, leading to unprofessional or even security-compromising situations. For illustrative purposes, consider the following scenarios. A first scenario is from an Engineer's Perspective. An engineer has multiple browser tabs open, including: Jira dashboard tracking project progress, PowerPoint with architecture diagrams, internal documentation page, and a personal email tab. When the engineer joins a sprint review meeting, they need to present the architecture slides but accidentally share the Jira dashboard. This confuses stakeholders and causes unnecessary back-and-forth.

To resolve this potential issue, the system (AI system) identifies the right tab before sharing. The engineer joins a sprint review meeting, and the AI system detects the discussion is focused on software architecture. Instead of manually searching, the AI system highlights the PowerPoint slide deck containing the relevant architecture documentation. The engineer clicks “Share Suggested Tab”, avoiding delays and improving meeting efficiency.

In another example, a second scenario is from a designer's perspective. In this example, a UX designer working on multiple projects has the following open: Figma file for an upcoming app redesign, a previous client's branding file, an internal UI guideline document, and a social media tab. In a design critique meeting, the designer intends to share the app redesign but mistakenly shares the confidential client branding file. This creates compliance and security risks.

To resolve this potential issue, the system warns before accidental sharing. A designer, in a rush, selects a branding file meant for another client. The system detects a mismatch between the meeting agenda and the selected tab. A warning is displayed: “This tab may not be relevant to the meeting. Do you want to share the Figma redesign file instead?” The designer switches to the correct tab, preventing an embarrassing mistake.

In another example, a third scenario is from a Product Manager's Perspective. A product manager PM is preparing for a strategy meeting with the following tabs open: A Loop document tracking team OKRs, PowerPoint on upcoming feature roadmaps, a competitor analysis document, and a personal blog page. When prompted to share their screen, the PM accidentally presents the competitor analysis document, which was meant for internal discussion only.

To resolve this potential issue, the system prevents sensitive data exposure. The Product Manager PM tries to share their screen but unknowingly selects a personal blog tab. The system recognizes that the tab is unrelated to the meeting discussion and blocks the sharing attempt. The system suggests: “Instead, share the feature roadmap PowerPoint?” The PM selects the recommended tab, maintaining professionalism and preventing potential data leaks.

The disclosed techniques provide an AI-powered Smart Screen Share Director revolutionizes the way computers select and share screens in virtual meetings by intelligently identifying the most relevant tab or window based on the meeting's context, live text speeches and ongoing discussions and preventing accidental sharing of unrelated or sensitive content.

The disclosed techniques provide context-aware tab selection. In some embodiments, An AI Agent, also referred to herein as a LLM, continuously analyzes the meeting title, agenda, and live discussion topics to predict and suggest the most relevant tab or application window a user should share. Whether it's an engineer debugging in a code repository, a designer reviewing Figma files, or a product manager presenting a strategy deck, the AI ensures the right content is highlighted and displayed.

The disclosed techniques provide accidental sharing prevention. If a user unintentionally selects an irrelevant or potentially private tab, the system detects the mismatch between the shared content and the meeting context. It then alerts the user with a warning and suggests switching to the correct tab before sharing.

The disclosed techniques provide multi-application awareness. Unlike existing solutions limited to a single browser, our AI works across multiple browsers and applications, detecting open documents, design files, dashboards, and other relevant work materials to enhance screen-sharing efficiency.

By automating tab selection and preventing mis-shares, this AI-driven solution eliminates friction, saves time, and enhances security in virtual meetings, ensuring professionals across different roles can focus on collaboration instead of manually sorting through countless open tabs.

The AI-powered system follows a structured process to intelligently identify and suggest the most relevant tab. Meeting detection & context analysis detects when a meeting is active using Microsoft Teams, Zoom, or Google Meet integrations. The system extracts the meeting title, agenda, and real-time discussion topics using Azure Cognitive Services speech-to-text and NLP models. The system also performs tab indexing & classification scans open browser tabs Edge, Chrome, Firefox using browser extension APIs. The system uses metadata analysis titles, content previews, file names to classify tabs into categories: presentations, documents, project management tools, and external resources. The system also performs AI-based prioritization & recommendation matches real-time meeting discussion topics with indexed tabs. The system also prioritizes tabs based on relevance using AI ranking models. The system then generates data that suggests the most relevant tab with a “Share Suggested Tab” prompt. The system also provides accidental sharing prevention when it detects that a user selects an irrelevant or sensitive tab. The system generates a visual a warning: “This tab may not be relevant. Do you want to share another tab, e.g., Tab B, instead?” If the user proceeds, AI verifies if the tab contains confidential information and blocks the action if necessary.

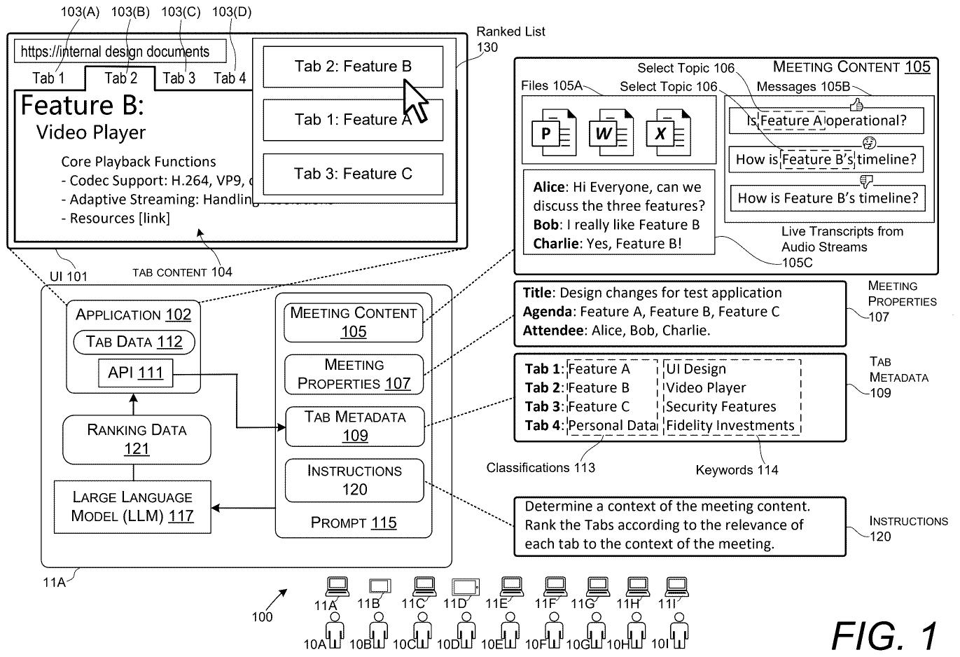

FIG. 1 is a block diagram of a system 100 for generating a list of ranked tab candidates based on a detected context of a meeting. The system analyzes the shared content of a meeting to determine the context of the meeting activity. The meeting activity includes the analysis of shared files, audio streams of live voice conversations, shared chat messages, video streams depicting user gestures, emails, etc. The system also analyzes the content of each tab of the browser applications. The system then generates a list of ranked browser tabs based on a match between each browser tab and the context of the meeting. As the context changes, the ordering of the tabs are re-arranged to match the top-ranking browser tab with a new context of the meeting.

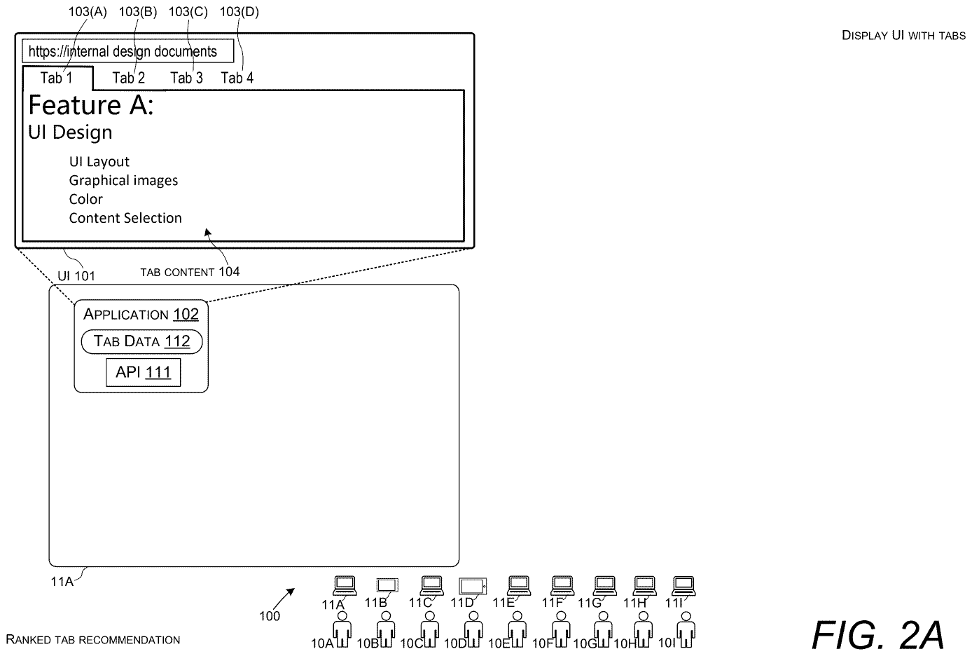

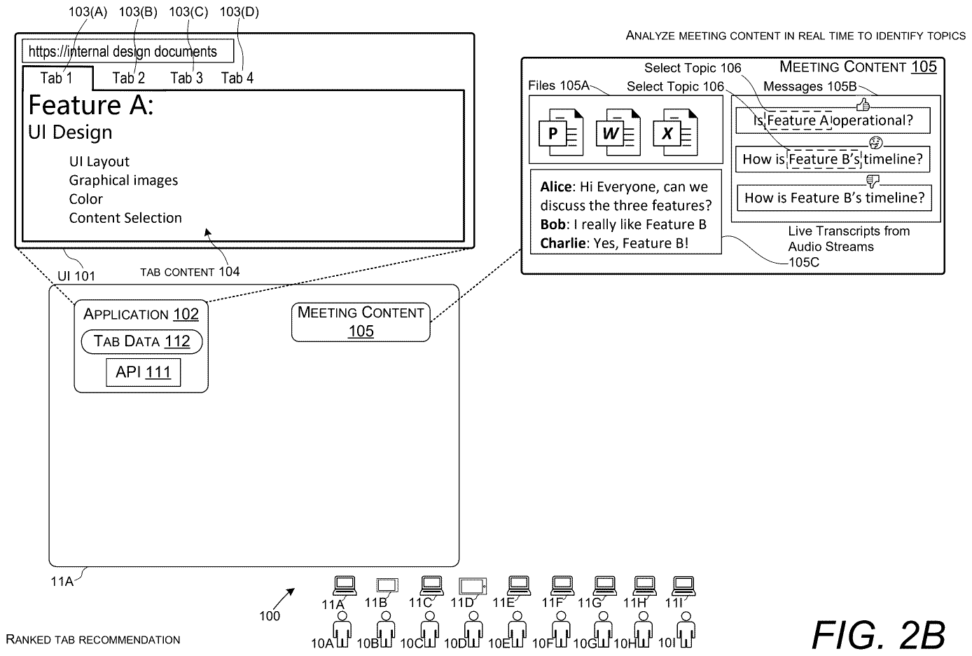

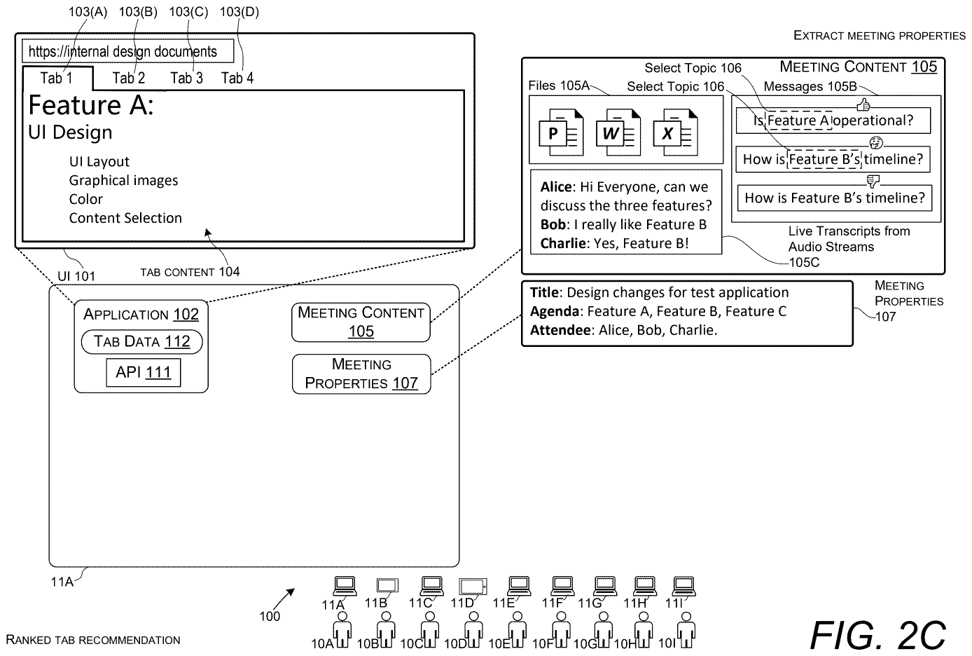

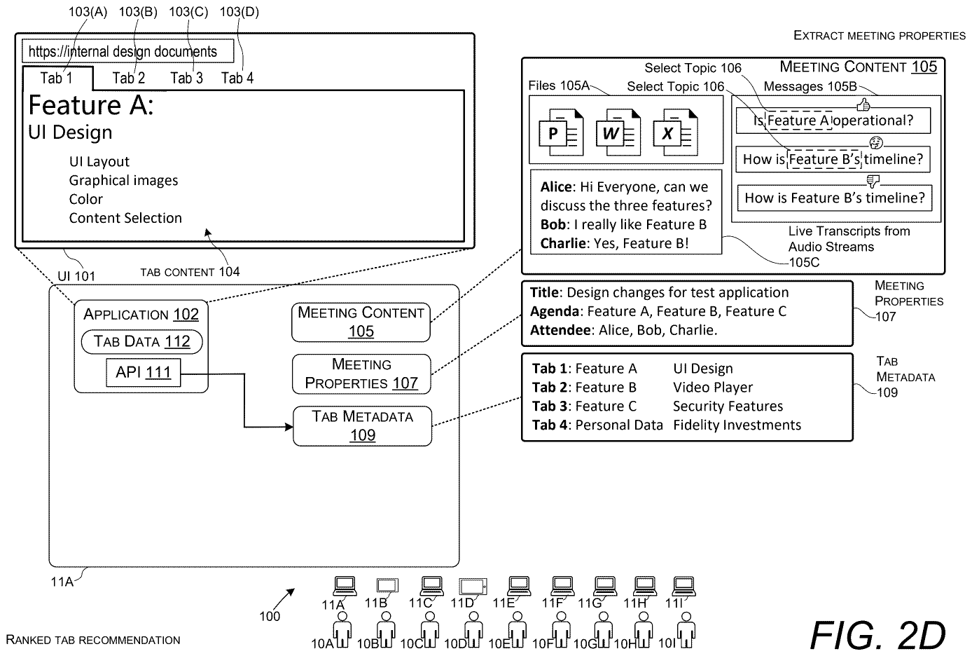

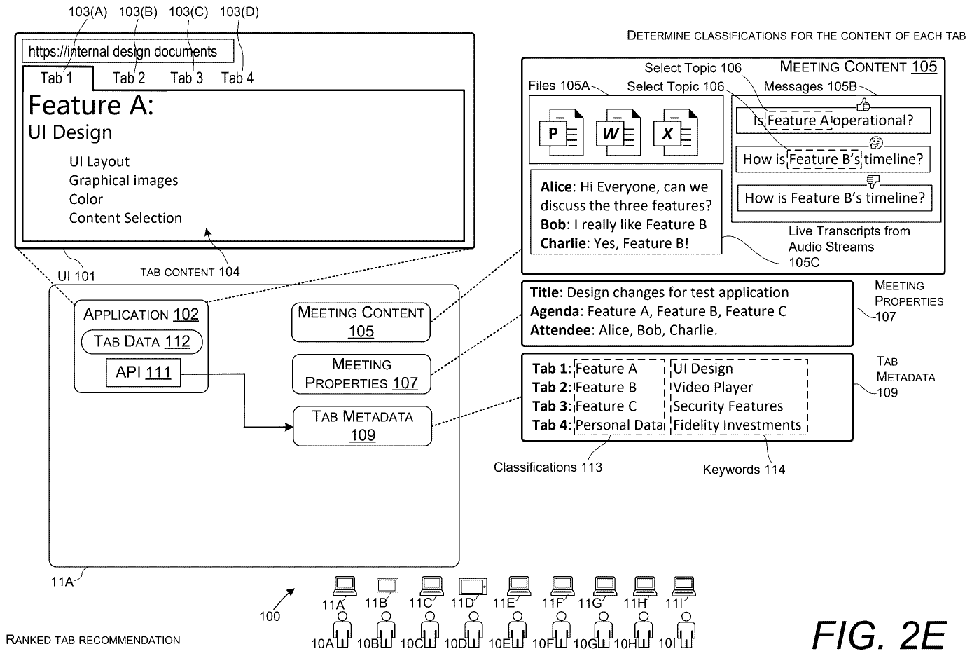

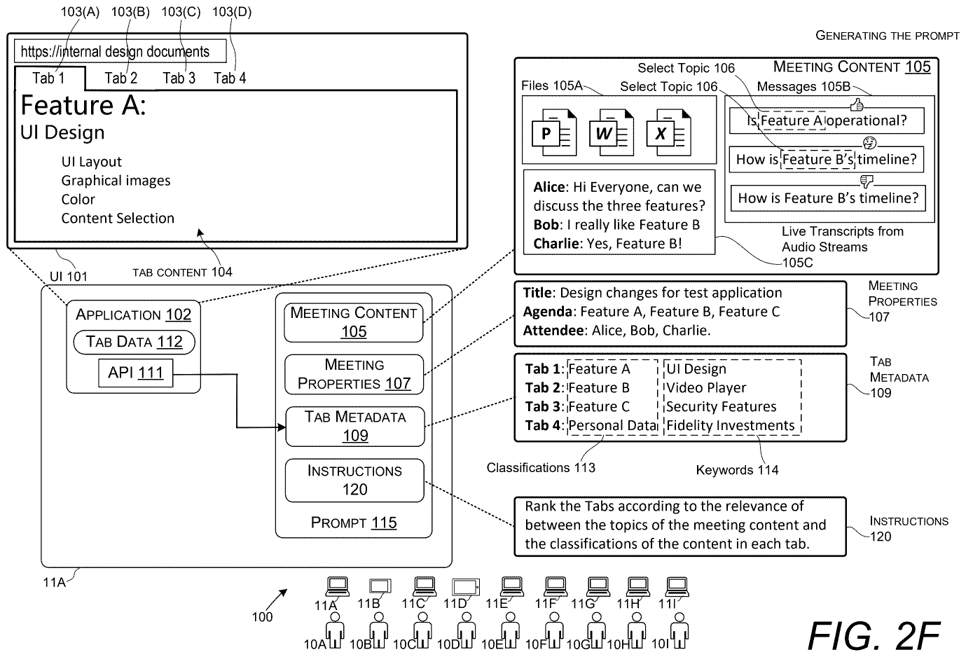

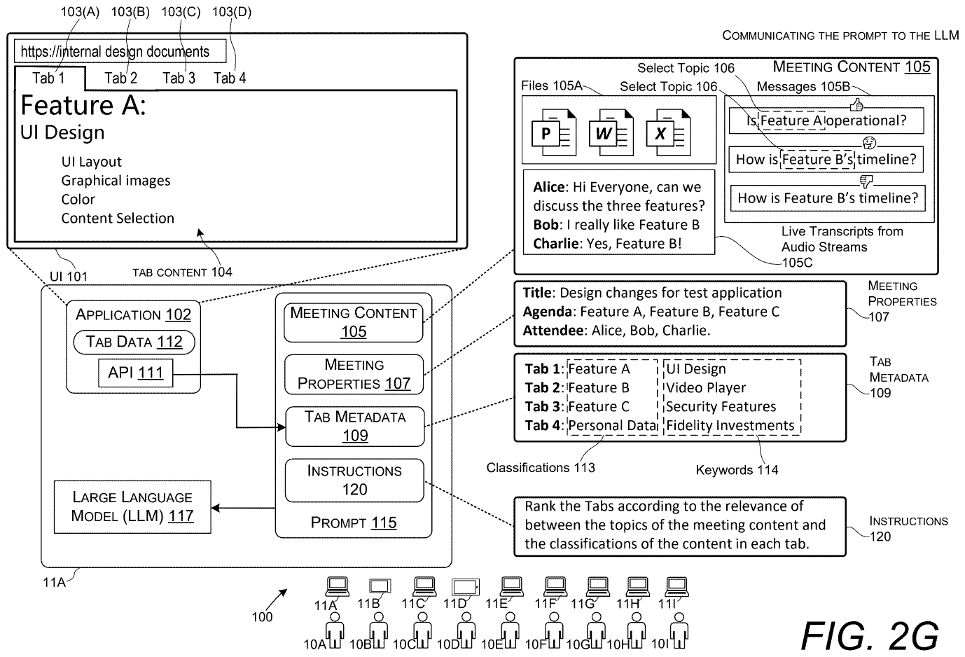

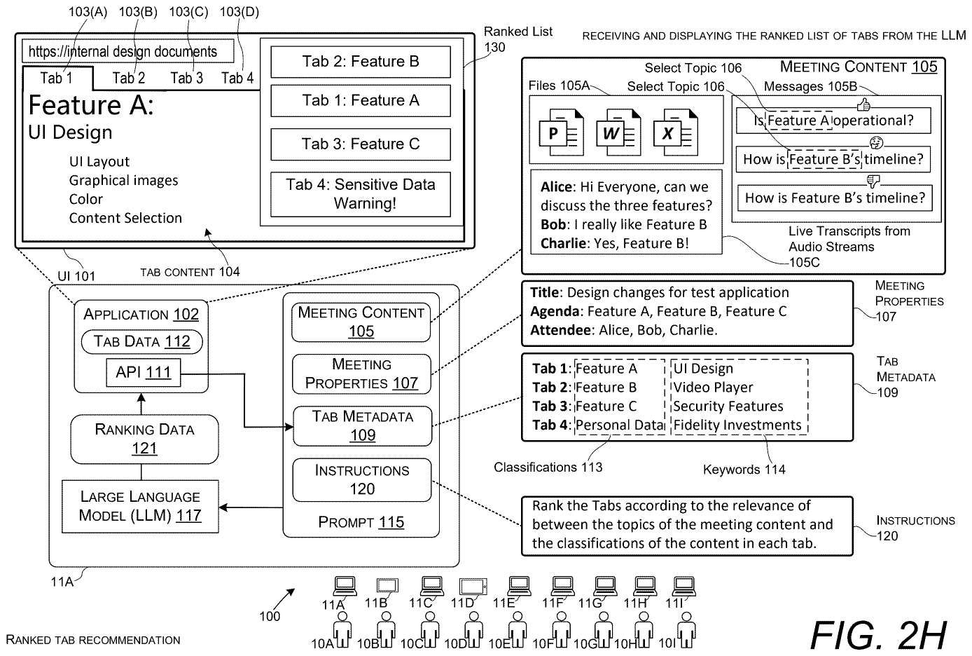

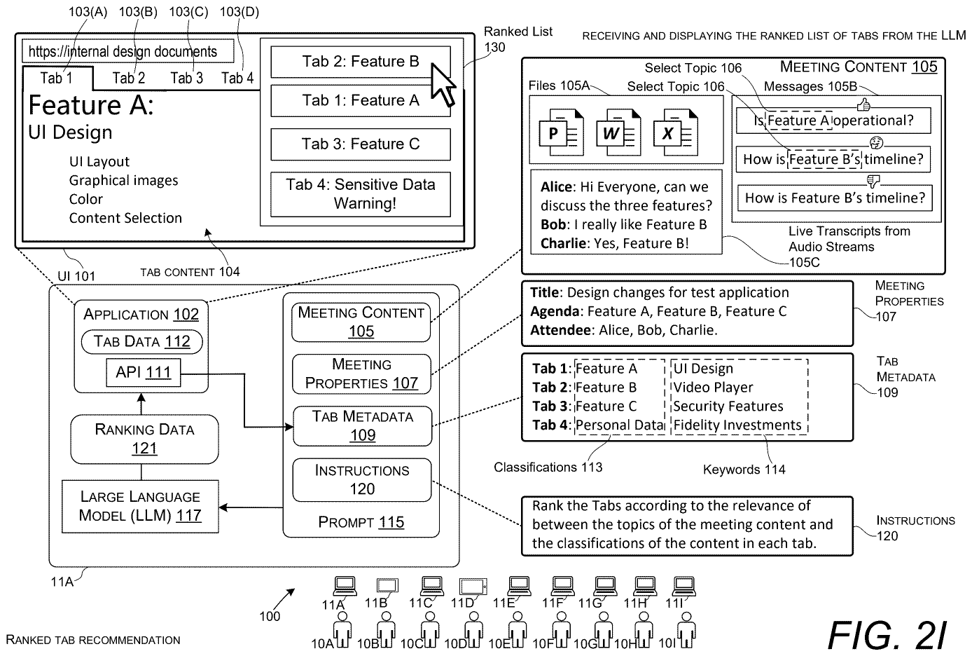

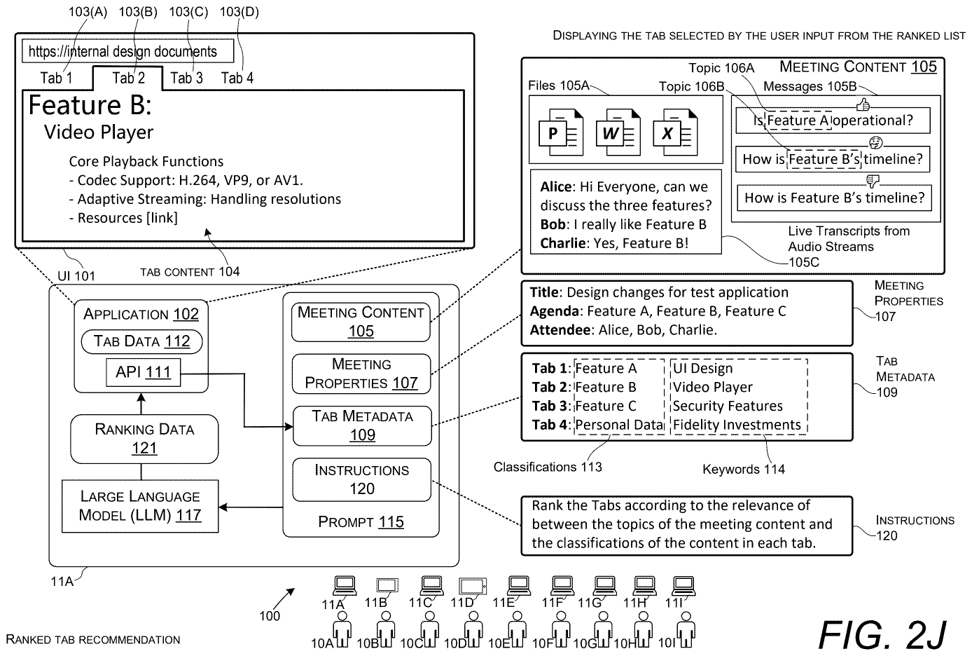

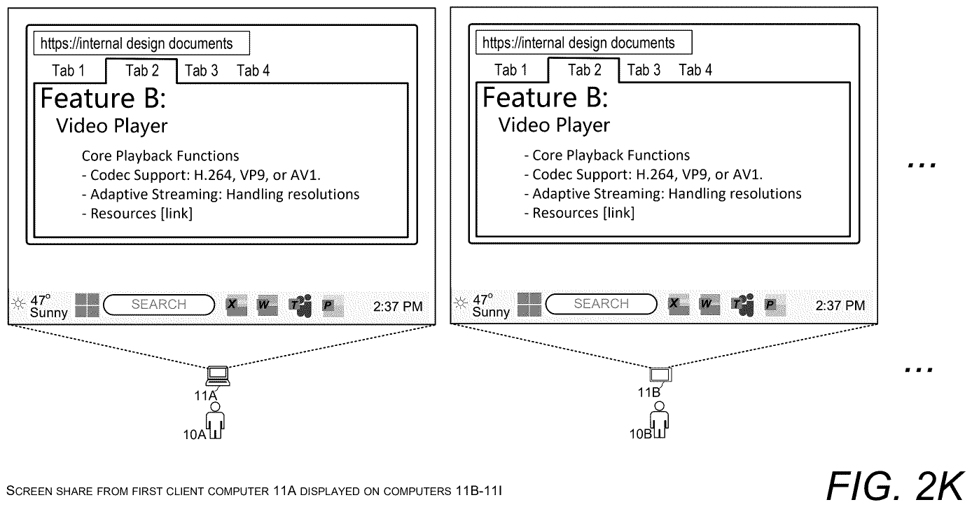

Referring now to FIGS. 2A-2K in conjunction with FIG. 1, a more detailed description of a process for controlling a selection of a display tab for a browser application is shown and described below. As shown in FIG. 2A, the system displays a browser UI having multiple tabs. This includes causing a display of a user interface 101 of a browser application 102 on a first computing device 11A of a plurality of computers 11. The browser application 102 is configured to individually display a selected tab 103B from a plurality of tabs 103. Individual tabs of the plurality of tabs 103 each contain content 104 having a context, e.g., one or more topics.

As shown in FIG. 2B, the system extracts real-time content from audio streams, messages, and shared files. This includes extracting meeting content 105 from files 105A, messages 105B, and transcripts 105C transcribed from live audio streams communicated between the plurality of participants. Also shown in FIG. 2B, the system determines topics from the real-time meeting content identify keywords from the transcripts. This includes identifying select topics 106 from a plurality of topics 106 from the meeting content 105.

As shown in FIG. 2C, this includes extracting the meeting title, agenda, and real-time discussion topics. The meeting object can be generated by any suitable calendaring program, such as Outlook. This process can include extracting meeting properties 107 from a meeting object, the meeting properties including at least one of a meeting title and a meeting agenda.

As shown in FIG. 2D, the system scan the tabs in the browser for tab indexing and classification: In one embodiment, this includes a direct mapping where a database can include keywords and associated classifications. When the content of a specific tab has keywords that have a threshold match with keywords that are associated with a particular classification, the system selects that particular classification for that specific tab. In another embodiment, the system can select classifications based on an AI prompt. For example, a prompt having the content of a tab as an input may be generated causing an LLM to select a classification for the content of that tab.

This system also generates tab metadata 109 for individual tabs 103 of the browser application by accessing the content 104 of each tab using an application programing interface API 111 of the browser application. The API 111 is configured to provide access to tab data 112 that includes at least one of titles, content previews, file names, and content of external resources linked in the content of each tab, the tab metadata 109 defining a plurality of classifications 113 derived from the tab data 112.

As shown in FIG. 2E, the system can assign a classification for each tab. This can include assigning individual classifications 113 for individual tabs 103 from the plurality of classifications. The individual classifications are selected based on threshold match between the metadata of each tab and individual keywords 114 associated with each classification 113.

The system can utilize a prompt for the analysis of the meeting content and tab classifications. As shown in FIG. 2F, this includes generating a prompt 115 for causing a large language model 117 to determine a ranking of the tabs 103 of the browser application 102. The prompt 115 can include live meeting content, such as the meeting properties 107, and the classifications 113 of the individual tabs 103. The input data also includes keywords for each tab classification. This includes individual keywords 114 associated with each classification 113 associated with each tab 103. The instructions 120 are also configured to cause the LLM 117 to rank the individual tabs 103 based on matching criteria between the keywords 114 associated with each classification of each tab and the select topics 106 identified from the meeting content.

As shown in FIG. 2G, the system also includes communicating the prompt to the LLM. This includes communicating the prompt to the LLM, causing the LLM to generate ranking data 121 comprising a prioritized list of select tabs that meet one or more ranking thresholds or ranking criteria. For example, Feature B (the Video Player) classification can be selected if the keywords associated with the classification appear in the meeting content more than a threshold number of times, or if keywords associated with the Feature B classification appear in the meeting content more than keywords associated with other classifications, e.g., Feature A, Feature C, etc.

In some embodiments, a priority or ranking can be determined for each tab is based on the matching criteria between the keywords 114 associated with each classification of each tab and the select topics 106. For example, Feature B (the Video Player) classification can have a higher ranking than Feature A if the keywords associated with Feature B appear in the meeting content more than keywords associated with Feature A. The priority of each tab can also be determined based on a relevancy score generated by the LLM using a context match between the content of each tab relative to a context determined for by the meeting content.

As shown in FIG. 2H, the system receives the ranking data 121 from the LLM comprising the prioritized list of select tabs that meet the one or more ranking thresholds. This also includes excluding tabs from the list that do not meet the ranking thresholds. Thus, if a tab has content is not related to any topic of a meeting, or if a tab has content that is related to a sensitive topic, the system excludes such tabs from the list.

The system displays the ranked list. This can be only on the device having the user that has a particular role, e.g., a presenter role in the meeting. The system can restrict the display of the ranked list from being displayed on other client computers of other meeting attendees having other roles, e.g., audience roles. As shown in FIG. 2H, the system can display the ranked list as a list of tabs. The list can be limited to the tabs that meet the threshold the thresholds or criteria described above. This process can include causing a display of a ranked list 130 using the ranking data comprising prioritized list of select tabs that meet the one or more ranking thresholds. A warning can also be displayed if a tab has sensitive data. Each menu can also indicate which application a tab belongs to. For instance, the first tab may be from a Firefox browser application, and the second tab may be from a Chrome browser.

The system can also control the display of the displayed tabs. The control can be confirmed by a user as shown in FIG. 2I, where the system receives a selection of a tab. Or the system can automatically display one of the top ranking tabs. As shown in FIG. 2J, the system can display the select tab in response to the selection of the select tab 103B by controlling the browser application 102 to display of the content associated with the select tab 103B. As shown in FIG. 2K, the system can screen share the selected tab with other client computers. This can include causing one or more remote computing devices 11B-11I of the plurality of devices to concurrently display content associated with the select tab 103B in a screen sharing session. The screen sharing session enables the first computing device 11A to control the display of the content on the remote computing devices 11B-11I. An input for causing a modification of the content associated with the select tab 103B that caused by an input at the first computing device 11A, also causes the same modification to the content on the remote computing devices 11B-11I, as the remote devices mirror the display that is controlled by the presenter, User 10A.

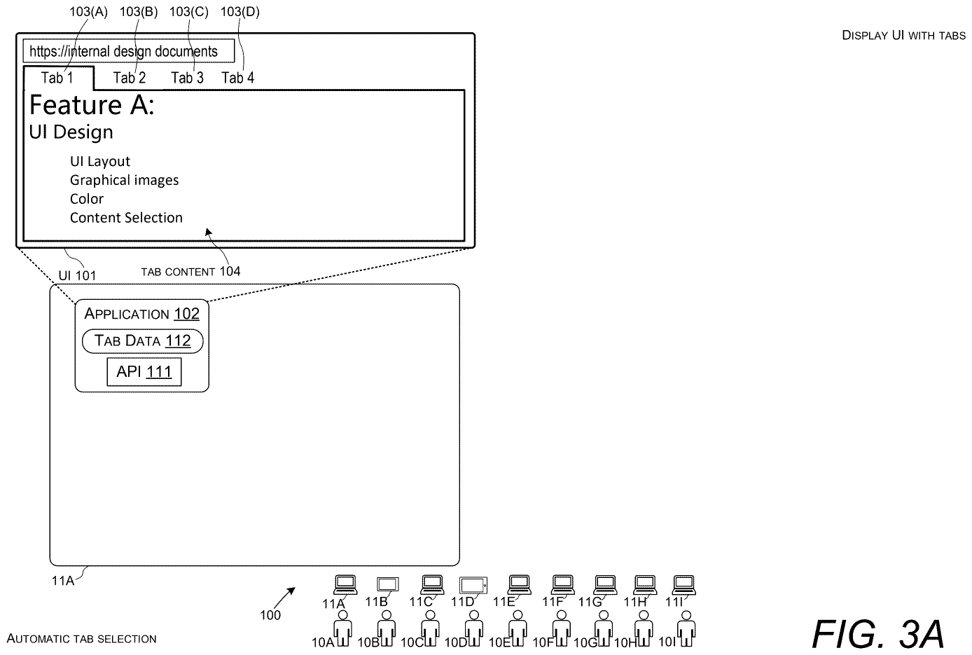

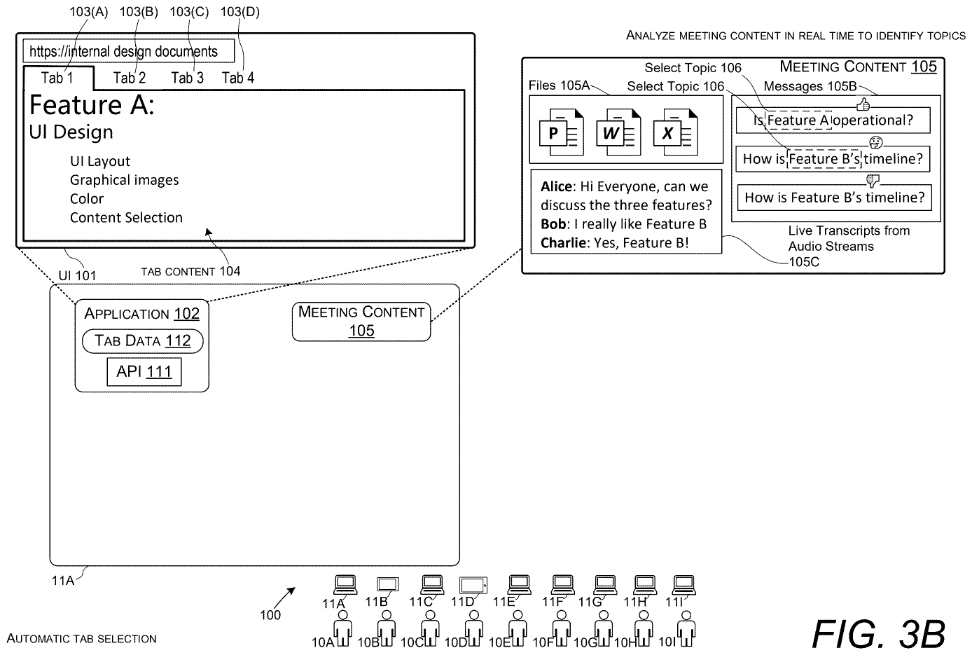

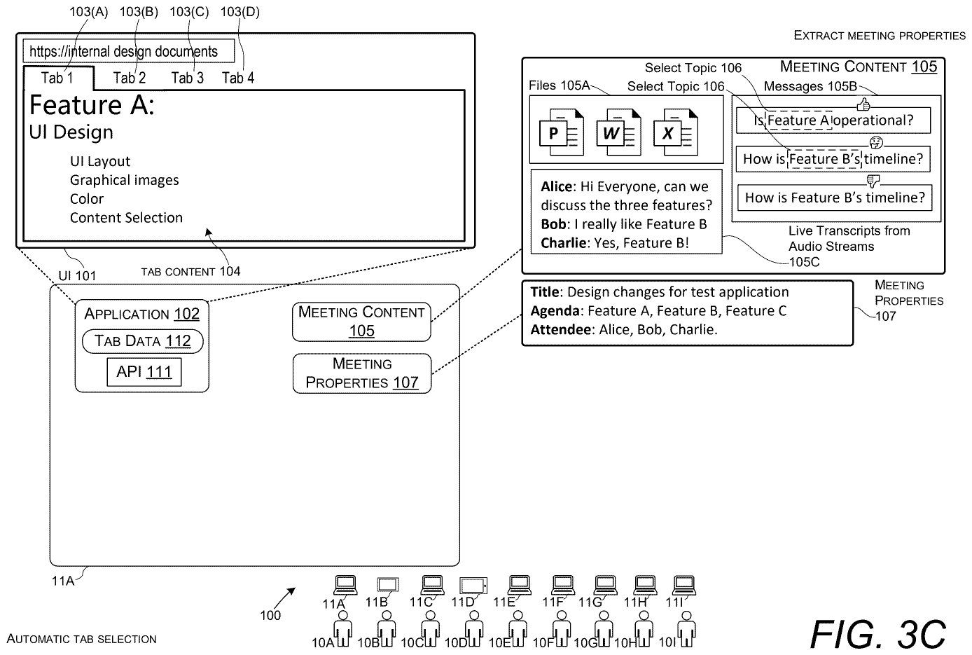

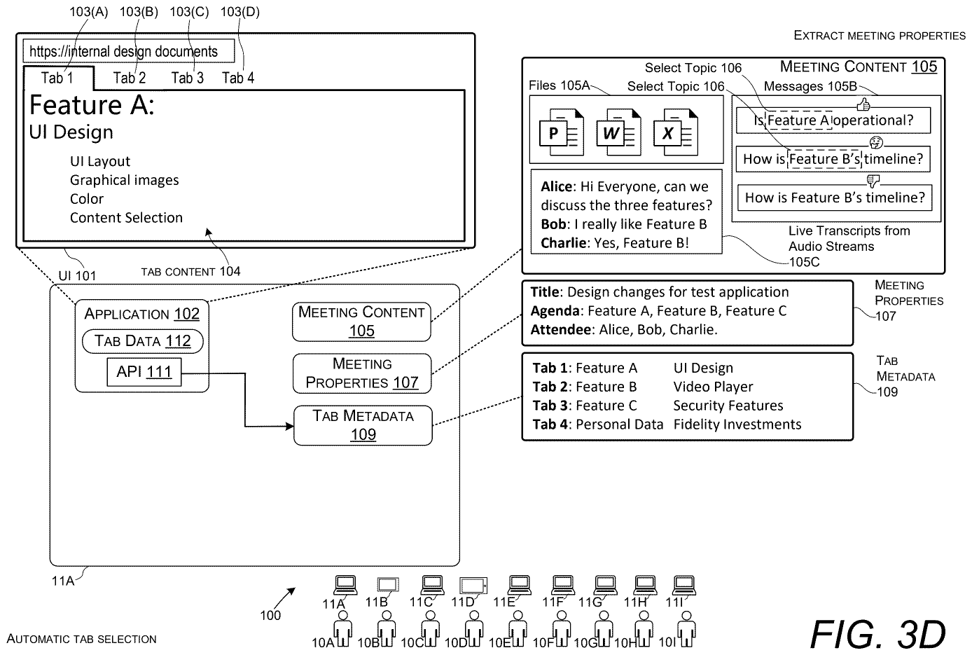

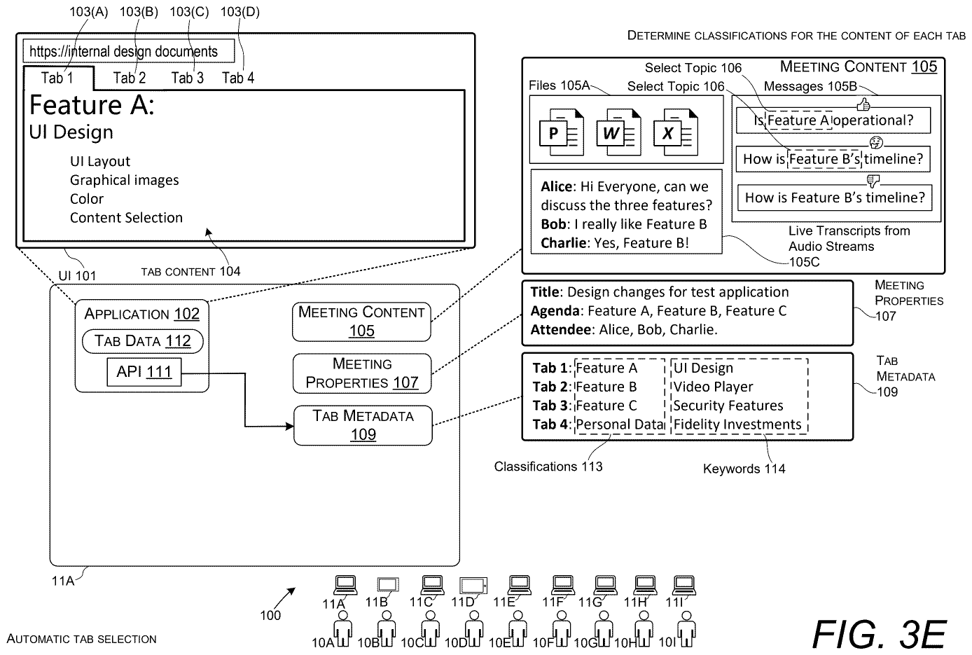

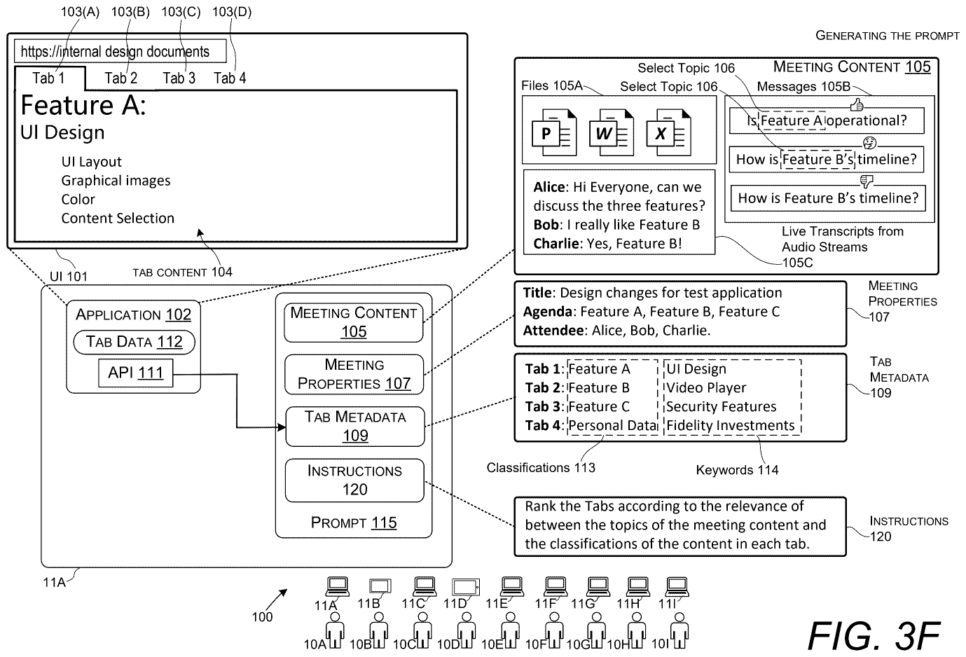

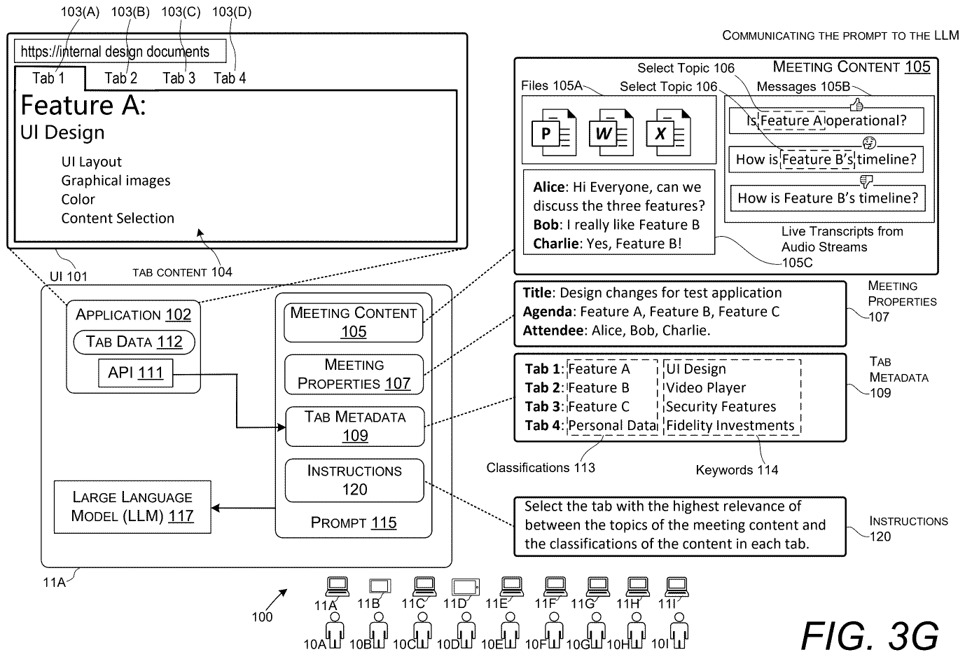

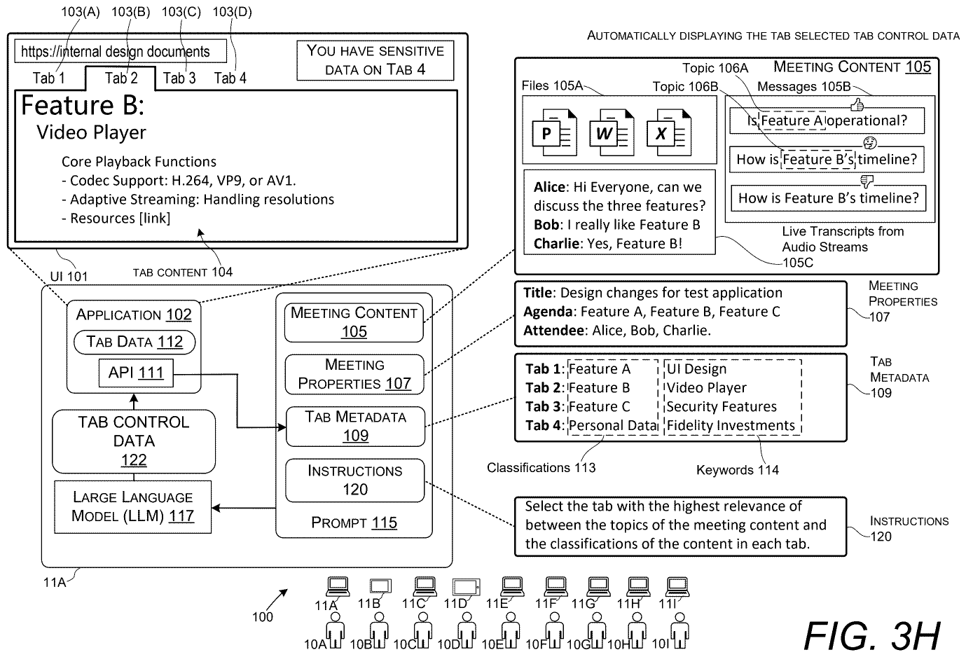

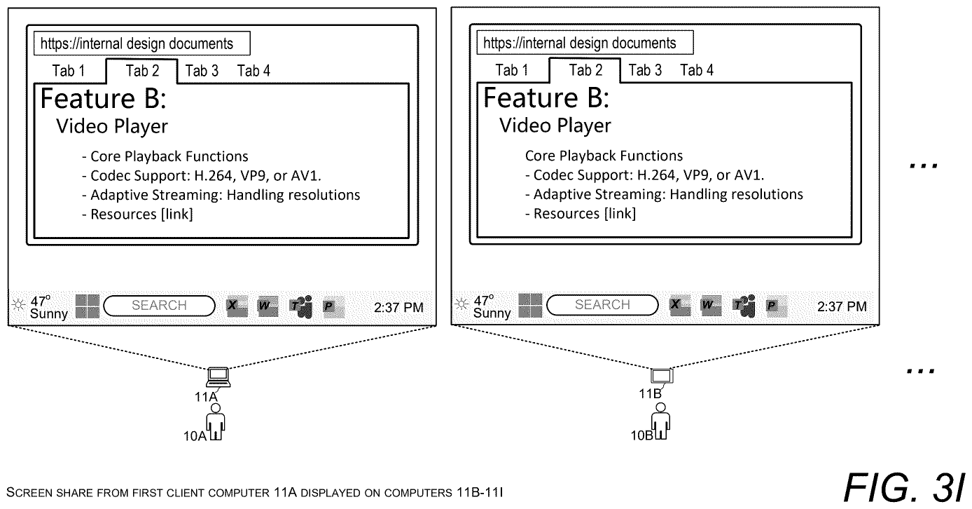

Referring now to FIGS. 3A-3I in conjunction with FIG. 1, a more detailed description of a process for automatically selecting a tab for display, such as the highest ranking tab, is shown and described below. As shown in FIG. 3A, the system displays a browser UI having multiple tabs. This can be multiple browser applications or a single browser application. The one or more applications can cause a display of a user interface 101 of a browser application 102 on a first computing device 11A of a plurality of computers 11, the browser application 102 configured to individually display a selected tab 103B from a plurality of tabs 103. The individual tabs of the plurality of tabs 103 each contain content 104 having a context.

As shown in FIG. 3B, the system extracts real-time content from audio streams, messages, and shared files. This includes extracting meeting content 105 from files 105A, messages 105B, and transcripts 105C transcribed from live audio streams communicated between the plurality of participants, The system can also determine topics from the real-time meeting content identify keywords from the transcripts. This includes identify select topics 106 from a plurality of topics 106 from the meeting content 105. As shown in FIG. 3C, the system extracts the meeting title, agenda, and real-time discussion topics. This includes extracting meeting properties 107 from a meeting object, the meeting properties including at least one of a meeting title and a meeting agenda;

As shown in FIG. 3D, the system scan the tabs in the browser for tab indexing and classification. In a first embodiment, the system uses direct mapping to determine a classification for each tab. In a second embodiment, the system uses AI to determine a classification for each tab. In each embodiment, the system generates tab metadata 109 for individual tabs 103 of the browser application by accessing the content 104 of each tab using an application programing interface API 111 of the browser application, wherein the API 111 provides access to tab data 112 that includes at least one of titles, content previews, file names, and content of external resources linked in the content of each tab, the tab metadata 109 defining a plurality of classifications 113 derived from the tab data 112.

As shown in FIG. 3E, the system assigns a classification for each tab. This can include assigning individual classifications 113 for individual tabs 103 from the plurality of classifications, wherein the individual classifications are selected based on threshold match between the metadata of each tab and individual keywords 114 associated with each classification 113.

As shown in FIG. 3F, the system can generate a prompt for the LLM. This can include generating a prompt 115 for causing a large language model 117 to determine a ranking of the tabs 103 of the browser application 102. The prompt 115 can include input data includes the live meeting content. More specifically, the input data can comprise the meeting content 105, the meeting properties 107, and the classifications 113 of the individual tabs 103. The input data also includes keywords for each tab classification. Specifically, the input data further comprises the individual keywords 114 associated with each classification 113 associated with each tab 103. The prompt also includes instructions 120 for causing the LLM 117 to generate tab control data indicating a select tab 103B from the plurality of tabs 103, based on matching criteria between the classification of the select tab and the select topics 106 identified from the meeting content 105.

As shown in FIG. 3G, the system communicates the prompt to the LLM. This can include communicating the prompt to the LLM, causing the LLM to generate tab control data 122 indicating the select tab 103B from the plurality of tabs 103, based on matching criteria between the classification of the select tab and the select topics 106 identified from the meeting content 105. As shown in FIG. 3H, the system can receive the tab control data and display a warning about the potential danger of sensitive information. The system can receive the tab control data from the LLM for causing a display of the select tab 103B. This includes, in response to the tab control data, controlling the browser application 102 to display of the content associated with the select tab 103B. As shown in FIG. 3I, the system can screen share the selected tab to other computers. This can include causing one or more remote computing devices 11B-11I of the plurality of devices to concurrently display content associated with the select tab 103B in a screen sharing session, the screen sharing session enabling the first computing device 11A to control the display of the content on the remote computing devices 11B-11I, wherein a modification of the content associated with the select tab 103B caused by an input at the first computing device 11A causes the same modification to the content on the remote computing devices 11B-11I.

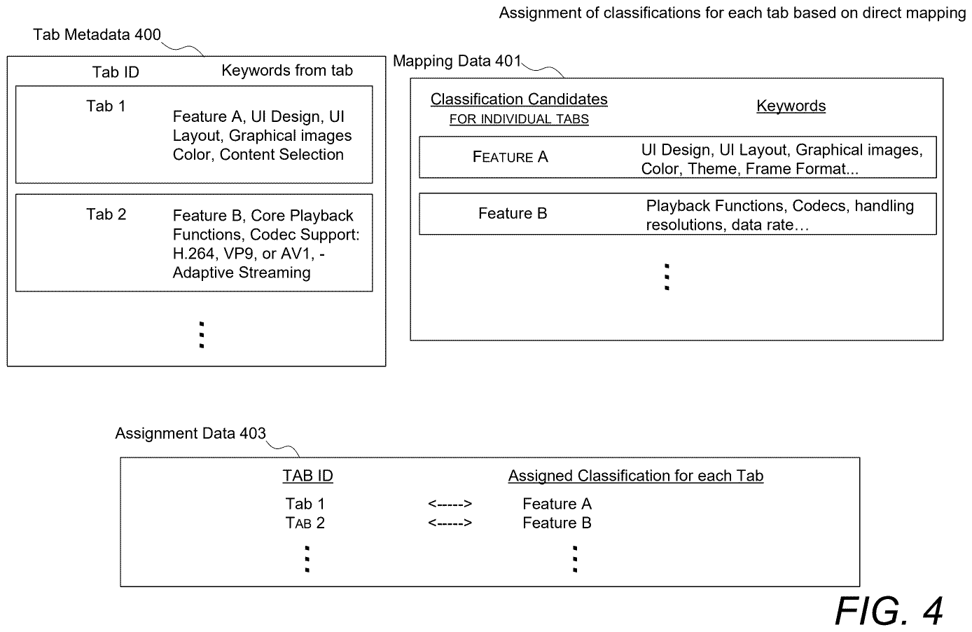

Referring now to FIG. 4, an embodiment using direct mapping for assigning individual classifications for each tab is shown and described below. In this embodiment, the system assigns individual classifications for individual tabs 103 by accessing mapping data defining classification candidates each associated with one or more keywords. This is done by selecting an individual classification candidate from the mapping data as a classification for a particular tab 103B in response to determining that the one or more keywords of the individual classification candidate has a threshold match with keywords of the metadata for the particular tab 103B. The system then assigns an individual classification to the particular tab in response to determining that the one or more keywords of the individual classification candidate has the threshold match with keywords of the metadata for the particular tab.

The system can also use AI Agents for assigning individual classifications for each tab. This can include generating a preprocessing prompt to cause one or more agents to determine an individual classification to a particular tab, wherein instructions of the preprocessing prompt includes classification candidates each associated with one or more keywords and keywords of the metadata for the particular tab. The system can also communicate the preprocessing prompt to the one or more agents for causing the one or more agents to determine the individual classification for the particular tab based on the match between the one or more keywords of the classification candidates and the keywords of the metadata for the particular tab. Then the system can use the individual classification in the prompt to determine a priority or ranking of the particular tab relative to other tabs. A top-ranking tab can also be automatically selected for display. Bottom tabs, or tabs below a threshold can be restricted from display in a screen sharing session.

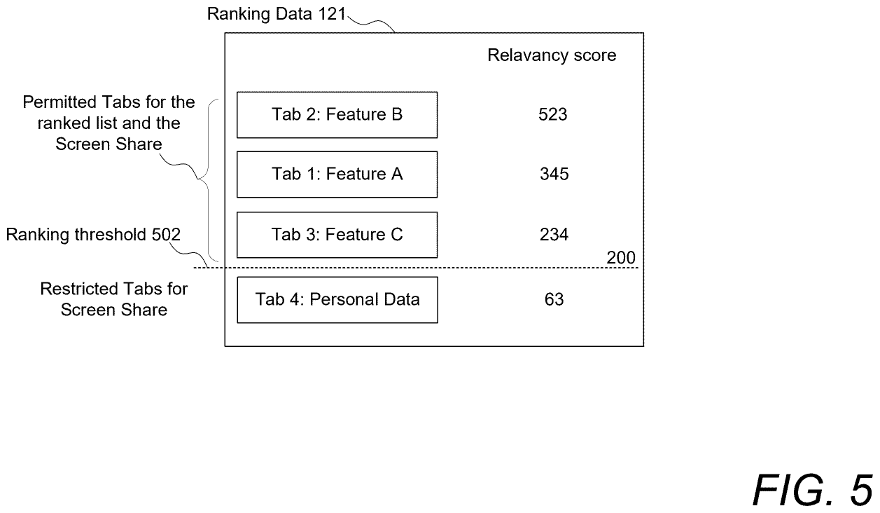

FIG. 5 illustrates a security and privacy feature where the system filters a tab that does not include meet the threshold criteria. In this embodiment, the system generates a relevancy score between the keywords 114 associated with an individual classification of an individual tab and the select topics 106 of the meeting content 105. The individual tab is ranked against other tabs based on the relevancy score for the individual tab and the relevancy score for the other tabs, wherein the ranked list 130 includes the individual tab if the relevancy score of that individual tab exceeds a ranking threshold 502. The system excludes the individual tab from the ranked list if the relevancy score of that individual tab does not exceed the ranking threshold 502. The system can also generate a visual notification or an audio notification to indicate that private data is at risk of being displayed.

In some embodiments, the system filters a tab that aligns with a specific security category, e.g., if the tab lines up with a category that has sensitive information. This can include a prompt having instructions that further cause the LLM to generate a relevancy score between the keywords 114 associated with an individual classification of an individual tab and the select topics 106 of the meeting content 105 that indicate sensitive information, wherein the ranked list 130 excludes the individual tab from the ranked list if the relevancy score of that individual tab exceeds a score threshold.

In some embodiments, the system trains the model based on a user correcting the tab. This includes generating an additional prompt for training the LLM, wherein the additional prompt includes addition input data indicating a change from the select tab to one other tab, the instructions causing the addition input data to train the LLM to change one or more weightings to raise one or more ranking scores or raise one or more relevancy scores for the one other tab for subsequent prompts sent to the LLM. For example, if the user selects Tab 1 after Tab 2 was recommended as a top tab. In response, the system trains the model so that Tab 1 has a greater probability of selection in future prompts given the user indication of the bias toward that tab.

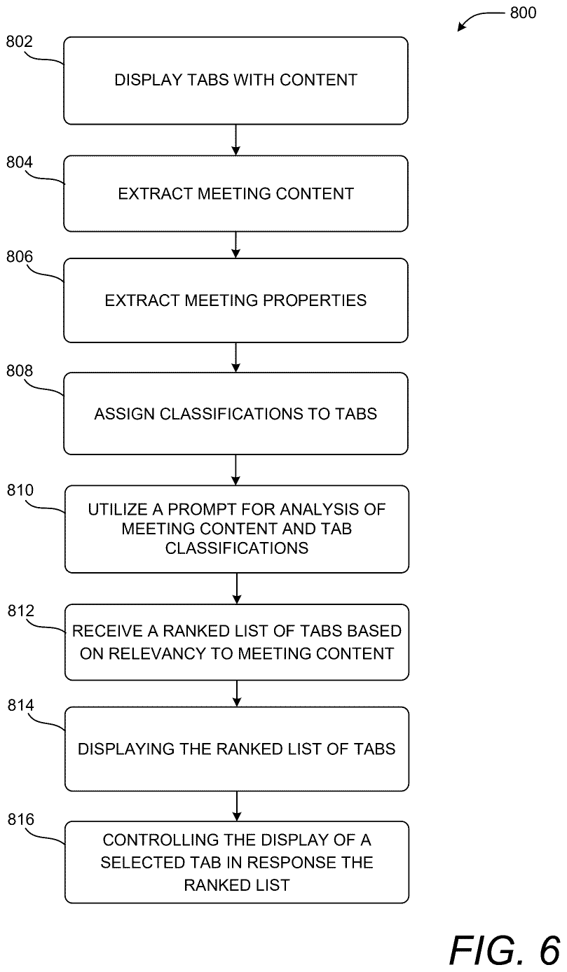

Turning now to FIG. 6, the following section describes aspects of a routine 800 for implementing aspects of the disclosed techniques. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 800 starts at operation 802, where the system displays tabs with content. As shown in FIG. 2A, the system displays a browser UI having multiple tabs. This includes causing a display of a user interface 101 of a browser application 102 on a first computing device 11A of a plurality of computers 11. The browser application 102 is configured to individually display a selected tab 103B from a plurality of tabs 103. Individual tabs of the plurality of tabs 103 each contain content 104 having a context, e.g., one or more topics. The tabs can be displayed from a single browser application or multiple browser applications.

At operation 804, the system extracts meeting content. As shown in FIG. 2B, the system extracts real-time content from audio streams, messages, and shared files. This includes extracting meeting content 105 from files 105A, messages 105B, and transcripts 105C generated from live audio streams communicated between the plurality of participants. Also shown in FIG. 2B, the system determines topics from the real-time meeting content identify keywords from the transcripts. This includes identifying select topics 106 from a plurality of topics 106 from the meeting content 105.

At operation 806, the system extracts meeting properties. As shown in FIG. 2C, this includes extracting the meeting title, agenda, and real-time discussion topics. The meeting object can be generated by any suitable calendaring program, such as Outlook. These operations can include extracting meeting properties 107 from a meeting object, the meeting properties including at least one of a meeting title and a meeting agenda.

At operation 808, the system assigns classifications to the tabs. As shown in FIG. 2D, the system scan the tabs in the browser for tab indexing and classification: In one embodiment, this includes a direct mapping where a database can include keywords and associated classifications. When the content of a specific tab has keywords that have a threshold match with keywords that are associated with a particular classification, the system selects that particular classification for that specific tab. In another embodiment, the system can select classifications based on an AI prompt. For example, a prompt having the content of a tab as an input may be generated causing an LLM to select a classification for the content of that tab.

Operation 808 can include generating tab metadata 109 for individual tabs 103 of the browser application by accessing the content 104 of each tab using an application programing interface API 111 of the browser application. The API 111 is configured to provide access to tab data 112 that includes at least one of titles, content previews, file names, and content of external resources linked in the content of each tab, the tab metadata 109 defining a plurality of classifications 113 derived from the tab data 112. The system can also scan for tabs across multiple browser applications to generate the tab metadata for all open tabs in the multiple browser applications.

As shown in FIG. 2E, the system can assign a classification for each tab. This can include assigning individual classifications 113 for individual tabs 103 from the plurality of classifications. The individual classifications are selected based on threshold match between the metadata of each tab and individual keywords 114 associated with each classification 113.

At operation 810 the system can utilize a prompt for the analysis of the meeting content and tab classifications. As shown in FIG. 2F, this includes generating a prompt 115 for causing a large language model 117 to determine a ranking of the tabs 103 of the browser application 102. The prompt 115 can include live meeting content, such as the meeting properties 107, and the classifications 113 of the individual tabs 103. The input data also includes keywords for each tab classification. This includes individual keywords 114 associated with each classification 113 associated with each tab 103. The instructions 120 are also configured to cause the LLM 117 to rank the individual tabs 103 based on matching criteria between the keywords 114 associated with each classification of each tab and the select topics 106 identified from the meeting content.

As shown in FIG. 2G, operation 810 also includes communicating the prompt to the LLM. This includes communicating the prompt to the LLM, causing the LLM to generate ranking data 121 comprising a prioritized list of select tabs that meet one or more ranking thresholds or ranking criteria. For example, Feature B (the Video Player) classification can be selected if the keywords associated with the classification appear in the meeting content more than a threshold number of times, or if keywords associated with the Feature B classification appear in the meeting content more than keywords associated with other classifications, e.g., Feature A, Feature C, etc.

In some embodiments, a priority or ranking can be determined for each tab is based on the matching criteria between the keywords 114 associated with each classification of each tab and the select topics 106. For example, Feature B (the Video Player) classification can have a higher ranking than Feature A if the keywords associated with Feature B appear in the meeting content more than keywords associated with Feature A. The priority of each tab can also be determined based on a relevancy score generated by the LLM using a context match between the content of each tab relative to a context determined for by the meeting content.

At operation 812, the system receives a ranked list of tabs based on relevancy to meeting content. As shown in FIG. 2H, the system receives the ranking data 121 from the LLM comprising the prioritized list of select tabs that meet the one or more ranking thresholds. This also includes excluding tabs from the list that do not meet the ranking thresholds. Thus, if a tab has content is not related to any topic of a meeting, or if a tab has content that is related to a sensitive topic, the system excludes such tabs from the list.

At operation 814, the system displays the ranked list. This can be only on the device having the user that has a particular role, e.g., a presenter role in the meeting. The system can restrict the display of the ranked list from being displayed on other client computers of other meeting attendees having other roles, e.g., audience roles. As shown in FIG. 2H, the system can display the ranked list as a list of tabs. The list can be limited to the tabs that meet the threshold the thresholds or criteria described above. This operation can include causing a display of a ranked list 130 using the ranking data comprising prioritized list of select tabs that meet the one or more ranking thresholds.

At operation 816, the system can control the display of the displayed tabs. The control can be confirmed by a user as shown in FIG. 2I, where the system receives a selection of a tab. Or the system can automatically display one of the top ranking tabs. As shown in FIG. 2J, the system can display the select tab in response to the selection of the select tab 103B by controlling the browser application 102 to display of the content associated with the select tab 103B. As shown in FIG. 2K, the system can screen share the selected tab with other client computers. This can include causing one or more remote computing devices 11B-11I of the plurality of devices to concurrently display content associated with the select tab 103B in a screen sharing session. The screen sharing session enables the first computing device 11A to control the display of the content on the remote computing devices 11B-11I. An input for causing a modification of the content associated with the select tab 103B that caused by an input at the first computing device 11A, also causes the same modification to the content on the remote computing devices 11B-11I, as the remote devices mirror the display that is controlled by the presenter, User 10A.

Although the examples described herein refer to the use of a large language model, the techniques disclosed herein can utilize any combination of suitable Natural Language Processing (NLP) algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The disclosed techniques can utilize any type of large language model. For example, based on the architecture there can be at least four types of LLM that are based on the technical structure of the model: Transformer-based models: modern LLMs use this (e.g., GPT, BERT, LLaMA), Autoregressive models (e.g., GPT): Predict the next word in a sequence, Autoencoding models (e.g., BERT): Understand and fill in blanks in a sentence, and Sequence-to-sequence models (e.g., T5): Convert one text sequence to another (e.g., translate English to French). In other examples, based on the purpose or use there can be at least three types of LLMs: General-purpose models: Like GPT-4, Claude, Gemini—trained broadly for many tasks, Domain-specific models: Trained for specialized fields like medicine (e.g., BioGPT), law, finance, or coding (e.g., CodeLlama, Codex), and Instruction-tuned models: Fine-tuned to follow human instructions better (e.g., ChatGPT, Alpaca, Mistral-Instruct).

An LLM can also include a Specialized Language Model (SLM) that is specifically trained to perform a set of functions. For example, a first SLM can be trained to determine issues with a code base, a second SLM can be trained to identify users, etc. Each SLM can be pre-trained with input data and instructions for causing each SLM to relate and identify specific sets of objects and data sets. The LLM or the SLM can be part of a server executing aspects of the present disclosure or the LLM or the SLM can be part of a separate computer in communication with the server.

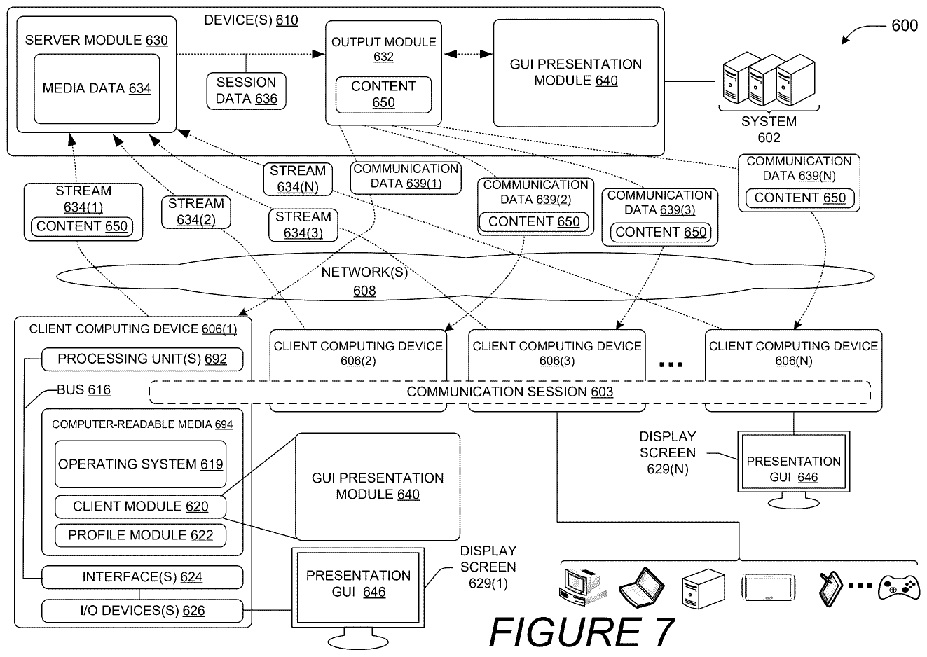

Turning now to FIG. 7, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 7 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 7 illustrates that client computing device 606(1) is in some way connected to a display device (e.g., a display screen 629(N)), which can display a UI according to the techniques described herein.

In the example environment 600 of FIG. 7, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 7) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 7, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

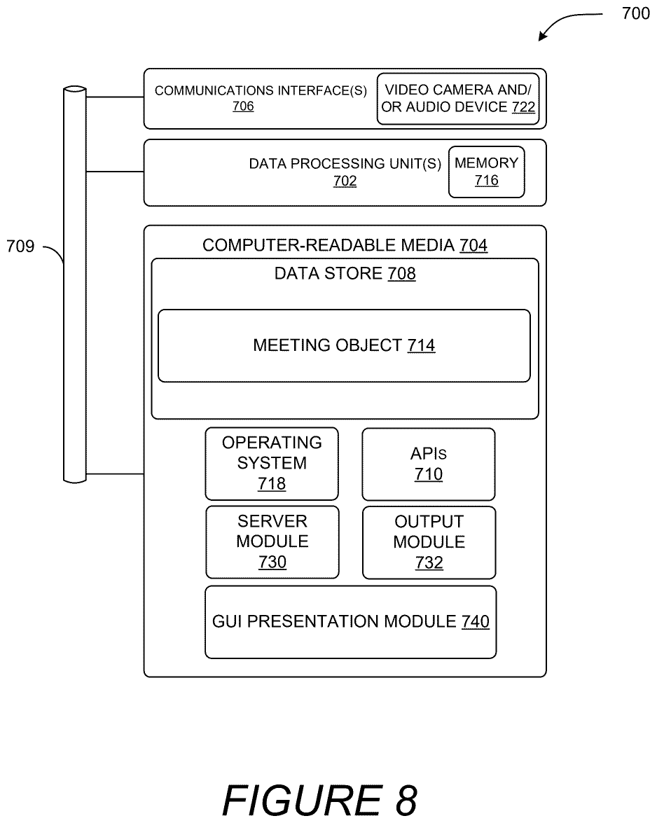

FIG. 8 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which is also referred to herein as computer-readable storage media, a computer-readable medium, or computer-readable storage medium, includes one or more of volatile memory, nonvolatile memory, and/or other persistent and/or auxiliary computer storage media, rotating storage medium such as a disk, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

A “computer-readable storage device” or a “computer-readable device” includes non-transitory computer-readable storage media such as one or more of volatile memory, nonvolatile memory implemented in any method or technology for storage of information such as computer-readable instructions, data structures, program modules, or other data. Thus, a computer-readable storage device includes tangible and/or physical forms of a hardware component that is part of a computing system or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), or flash memory, solid-state memory devices, storage arrays, network attached storage, storage area networks. The computer-readable storage device also includes a physical hardware device having circuitry and magnetic sensors, optical sensors, or other sensors for reading a compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, or any other physical locally stored medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the primary calendar and secondary calendar, and other session data that show the status and activity level of each user. The session data can include a total number of participants (e.g., users and/or client computing devices) in a communication session, activity that occurs in the communication session, a list of invitees to the communication session, and/or other data related to when and how the communication session is conducted or hosted. The data store 708 may also include a meeting object 714, which also includes session data described herein. The meeting object 714 can also include video, audio, or other content that can be shared in a meeting. The session data can also include permissions for each user. For example, session data can indicate that past meetings included users having speaker roles and other roles. The meeting object 714 also stores meeting parameters which stores a start time, an end time, attendee list, a meeting title, etc. The meeting object 714 also stores IDs for meeting data, such as files, user profiles, messages, emails, data streams, etc. The meeting object also includes links or stores files, messages and communication data exchanged during a meeting.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. The method for controlling a selection of a display tab for a browser application for communication a screen share session to a plurality of participants of a meeting, the method for execution on a computing system, the method comprising:
causing a display of a user interface of a browser application on a first computing device of a plurality of computers, the browser application configured to individually display a selected tab from a plurality of tabs, wherein individual tabs of the plurality of tabs each contain content having a context;
extracting meeting content from files, messages, and transcripts transcribed from live audio streams communicated between the plurality of participants,
identifying select topics from a plurality of topics from the meeting content;
extracting meeting properties from a meeting object, the meeting properties including at least one of a meeting title and a meeting agenda;
generating tab metadata for individual tabs of the browser application by accessing the content of each tab using an application programing interface (API) of the browser application, wherein the API provides access to tab data that includes at least one of titles, content previews, file names, and content of external resources linked in the content of each tab, the tab metadata defining a plurality of classifications derived from the tab data;
assigning individual classifications for individual tabs from the plurality of classifications, wherein the individual classifications are selected based on threshold match between the metadata of each tab and individual keywords associated with each classification;
generating a prompt for causing a large language model to determine a ranking of the tabs of the browser application, the prompt comprising:
input data comprising the meeting content, the meeting properties, and the classifications of the individual tabs,
the input data further comprises the individual keywords associated with each classification associated with each tab, and
instructions for causing the LLM to rank the individual tabs based on matching criteria between the keywords associated with each classification of each tab and the select topics identified from the meeting content and by using the meeting properties;
communicating the prompt to the LLM, causing the LLM to generate ranking data comprising a prioritized list of select tabs that meet one or more ranking thresholds, wherein the priority of each tab is based on the matching criteria between the keywords associated with each classification of each tab and the select topics of the meeting content;
receiving the ranking data from the LLM comprising the prioritized list of select tabs that meet the one or more ranking thresholds;
causing a display of a ranked list using the ranking data comprising prioritized list of select tabs that meet the one or more ranking thresholds;
receiving a selection of a select tab from the tabs displayed on the ranked list;
in response to the selection of the select tab, controlling the browser application to display of the content associated with the select tab; and
causing one or more remote computing devices of the plurality of devices to concurrently display content associated with the select tab in a screen sharing session, the screen sharing session enabling the first computing device to control the display of the content on the remote computing devices, wherein a modification of the content associated with the select tab caused by an input at the first computing device causes the same modification to the content on the remote computing devices.

2. The method of claim 1, wherein assigning individual classifications for individual tabs comprises:
accessing mapping data defining classification candidates each associated with one or more keywords;
selecting an individual classification candidate from the mapping data as a classification for a particular tab in response to determining that the one or more keywords of the individual classification candidate has a threshold match with keywords of the metadata for the particular tab; and
assigning an individual classification to the particular tab in response to determining that the one or more keywords of the individual classification candidate has the threshold match with keywords of the metadata for the particular tab.

3. The method of claim 1, wherein assigning individual classifications for individual tabs comprises:
generating a preprocessing prompt to cause one or more agents to determine an individual classification to a particular tab, wherein instructions of the preprocessing prompt includes classification candidates each associated with one or more keywords and keywords of the metadata for the particular tab;
communicating the preprocessing prompt to the one or more agents for causing the one or more agents to determine the individual classification for the particular tab based on the match between the one or more keywords of the classification candidates and the keywords of the metadata for the particular tab; and
using the individual classification in the prompt to determine a priority or ranking of the particular tab relative to other tabs.

4. The method of claim 1, wherein the instructions of the prompt further cause the LLM to:
generate a relevancy score between the keywords associated with an individual classification of an individual tab and the select topics of the meeting content, wherein the individual tab is ranked against other tabs based on the relevancy score for the individual tab and the relevancy score for the other tabs, wherein the ranked list includes the individual tab if the relevancy score of that individual tab exceeds a ranking threshold, wherein the system excludes the individual tab from the ranked list if the relevancy score of that individual tab does not exceed the ranking threshold; and
generate a visual notification or an audio notification to indicate that private data is at risk of being displayed.

5. The method of claim 1, wherein the instructions of the prompt further cause the LLM to generate a relevancy score between the keywords associated with an individual classification of an individual tab and the select topics of the meeting content, wherein the system excludes the individual tab from the ranked list if the relevancy score of that individual tab exceeds a score threshold and if the individual classification includes sensitive information.

6. The method of claim 1, wherein the method further comprises: generating an additional prompt for training the LLM, wherein the additional prompt includes addition input data indicating a change from the select tab to one other tab, the instructions causing the addition input data to train the LLM to change one or more weightings to raise one or more ranking scores or raise one or more relevancy scores for the one other tab for subsequent prompts sent to the LLM.

7. The method of claim 1, further comprising: scanning for tabs across multiple browser applications to generate the tab metadata for all open tabs in the multiple browser applications.

8. A computing system for controlling a selection of a display tab for a browser application for communication a screen share session to a plurality of participants of a meeting, the computing system comprising:
one or more processing units; and
a computer-readable storage medium having encoded thereon computer-executable instructions to cause the one or more processing units to:
cause a display of a user interface of a browser application on a first computing device of a plurality of computers, the browser application configured to individually display a selected tab from a plurality of tabs, wherein individual tabs of the plurality of tabs each contain content having a context;
extract meeting content from files, messages, and transcripts transcribed from live audio streams communicated between the plurality of participants,
identify select topics from a plurality of topics from the meeting content;
extract meeting properties from a meeting object, the meeting properties including at least one of a meeting title and a meeting agenda;
generate tab metadata for individual tabs of the browser application by accessing the content of each tab using an application programing interface of the browser application, wherein the API provides access to tab data that includes at least one of titles, content previews, file names, and content of external resources linked in the content of each tab, the tab metadata defining a plurality of classifications derived from the tab data;
assign individual classifications for individual tabs from the plurality of classifications, wherein the individual classifications are selected based on threshold match between the metadata of each tab and individual keywords associated with each classification;
generate a prompt for causing a large language model to determine a ranking of the tabs of the browser application, the prompt comprising:
input data comprising the meeting content, the meeting properties, and the classifications of the individual tabs,
the input data further comprises the individual keywords associated with each classification associated with each tab, and
instructions for causing the LLM to generate tab control data indicating a select tab from the plurality of tabs, based on matching criteria between the classification of the select tab and the select topics identified from the meeting content;
communicate the prompt to the LLM, causing the LLM to generate tab control data indicating the select tab from the plurality of tabs, based on matching criteria between the classification of the select tab and the select topics identified from the meeting content;
receive the tab control data from the LLM for causing a display of the select tab;
in response to the tab control data, controlling the browser application to display of the content associated with the select tab; and
cause one or more remote computing devices of the plurality of devices to concurrently display content associated with the select tab in a screen sharing session, the screen sharing session enabling the first computing device to control the display of the content on the remote computing devices, wherein a modification of the content associated with the select tab caused by an input at the first computing device causes the same modification to the content on the remote computing devices.

9. The computing system of claim 8, wherein assigning individual classifications for individual tabs comprises:
accessing mapping data defining classification candidates each associated with one or more keywords;
selecting an individual classification candidate from the mapping data as a classification for a particular tab in response to determining that the one or more keywords of the individual classification candidate has a threshold match with keywords of the metadata for the particular tab; and
assigning an individual classification to the particular tab in response to determining that the one or more keywords of the individual classification candidate has the threshold match with keywords of the metadata for the particular tab.

10. The computing system of claim 8, wherein assigning individual classifications for individual tabs comprises:
generating a preprocessing prompt to cause one or more agents to determine an individual classification to a particular tab, wherein instructions of the preprocessing prompt includes classification candidates each associated with one or more keywords and keywords of the metadata for the particular tab;
communicating the preprocessing prompt to the one or more agents for causing the one or more agents to determine the individual classification for the particular tab based on the match between the one or more keywords of the classification candidates and the keywords of the metadata for the particular tab; and
using the individual classification in the prompt to determine a priority or ranking of the particular tab relative to other tabs.

11. The computing system of claim 8, wherein the instructions of the prompt further cause the LLM to generate a relevancy score between the keywords associated with an individual classification of an individual tab and the select topics of the meeting content, wherein the individual tab is ranked against other tabs based on the relevancy score for the individual tab and the relevancy score for the other tabs, wherein the tab control data includes the individual tab if the relevancy score of that individual tab exceeds a ranking threshold, wherein the system excludes the individual tab from the tab control data tab control data if the relevancy score of that individual tab does not exceed the ranking threshold.

12. The computing system of claim 8, wherein the instructions of the prompt further cause the LLM to generate a relevancy score between the keywords associated with an individual classification of an individual tab and the select topics of the meeting content, wherein the system excludes the individual tab from the tab control data if the relevancy score of that individual tab exceeds a score threshold and if the individual classification includes sensitive information.

13. The computing system of claim 8, wherein the computer-executable instructions further cause the one or more processing units to: generate an additional prompt for training the LLM, wherein the additional prompt includes addition input data indicating a change from the select tab to one other tab, the instructions causing the addition input data to train the LLM to change one or more weightings to raise one or more ranking scores or raise one or more relevancy scores for the one other tab for subsequent prompts sent to the LLM.

14. The computing system of claim 8, wherein the computer-executable instructions further cause the one or more processing units to: scan for tabs across multiple browser applications to generate the tab metadata for all open tabs in the multiple browser applications.

15. A computer-readable storage medium having encoded thereon computer-executable instructions for controlling a selection of a display tab for a browser application for communication a screen share session to a plurality of participants of a meeting, the computer-executable instructions configured to cause one or more processing units of a computing system to:
cause a display of a user interface of a browser application on a first computing device of a plurality of computers, the browser application configured to individually display a selected tab from a plurality of tabs, wherein individual tabs of the plurality of tabs each contain content having a context;
extract meeting content from files, messages, and transcripts transcribed from live audio streams communicated between the plurality of participants,
identify select topics from a plurality of topics from the meeting content;
extract meeting properties from a meeting object, the meeting properties including at least one of a meeting title and a meeting agenda;
generate tab metadata for individual tabs of the browser application by accessing the content of each tab using an application programing interface of the browser application, wherein the API provides access to tab data that includes at least one of titles, content previews, file names, and content of external resources linked in the content of each tab, the tab metadata defining a plurality of classifications derived from the tab data;
assign individual classifications for individual tabs from the plurality of classifications, wherein the individual classifications are selected based on threshold match between the metadata of each tab and individual keywords associated with each classification;
generate a prompt for causing a large language model to determine a ranking of the tabs of the browser application, the prompt comprising:
input data comprising the meeting content, the meeting properties, and the classifications of the individual tabs,
the input data further comprises the individual keywords associated with each classification associated with each tab, and
instructions for causing the LLM to rank the individual tabs based on matching criteria between the keywords associated with each classification of each tab and the select topics identified from the meeting content;
communicate the prompt to the LLM, causing the LLM to generate ranking data comprising a prioritized list of select tabs that meet one or more ranking thresholds, wherein the priority of each tab is based on the matching criteria between the keywords associated with each classification of each tab and the select topics of the meeting content;
receive the ranking data from the LLM comprising the prioritized list of select tabs that meet the one or more ranking thresholds;
cause a display of a ranked list using the ranking data comprising prioritized list of select tabs that meet the one or more ranking thresholds;
receive a selection of a select tab from the tabs displayed on the ranked list;
in response to the selection of the select tab, controlling the browser application to display of the content associated with the select tab; and
cause one or more remote computing devices of the plurality of devices to concurrently display content associated with the select tab in a screen sharing session, the screen sharing session enabling the first computing device to control the display of the content on the remote computing devices, wherein a modification of the content associated with the select tab caused by an input at the first computing device causes the same modification to the content on the remote computing devices.

16. The computer-readable storage medium of claim 15, wherein assigning individual classifications for individual tabs comprises:
accessing mapping data defining classification candidates each associated with one or more keywords;
selecting an individual classification candidate from the mapping data as a classification for a particular tab in response to determining that the one or more keywords of the individual classification candidate has a threshold match with keywords of the metadata for the particular tab; and
assigning an individual classification to the particular tab in response to determining that the one or more keywords of the individual classification candidate has the threshold match with keywords of the metadata for the particular tab.

17. The computer-readable storage medium of claim 15, wherein assigning individual classifications for individual tabs comprises:
generating a preprocessing prompt to cause one or more agents to determine an individual classification to a particular tab, wherein instructions of the preprocessing prompt includes classification candidates each associated with one or more keywords and keywords of the metadata for the particular tab;
communicating the preprocessing prompt to the one or more agents for causing the one or more agents to determine the individual classification for the particular tab based on the match between the one or more keywords of the classification candidates and the keywords of the metadata for the particular tab; and
using the individual classification in the prompt to determine a priority or ranking of the particular tab relative to other tabs.

18. The computer-readable storage medium of claim 15, wherein the instructions of the prompt further cause the LLM to generate a relevancy score between the keywords associated with an individual classification of an individual tab and the select topics of the meeting content, wherein the individual tab is ranked against other tabs based on the relevancy score for the individual tab and the relevancy score for the other tabs, wherein the ranked list includes the individual tab if the relevancy score of that individual tab exceeds a ranking threshold, wherein the system excludes the individual tab from the ranked list if the relevancy score of that individual tab does not exceed the ranking threshold.

19. The computer-readable storage medium of claim 15, wherein the instructions of the prompt further cause the LLM to generate a relevancy score between the keywords associated with an individual classification of an individual tab and the select topics of the meeting content, wherein the system excludes the individual tab from the ranked list if the relevancy score of that individual tab exceeds a score threshold and if the individual classification includes sensitive information.

20. The computer-readable storage medium of claim 15, wherein the computer-executable instructions further cause the one or more processing units to: generate an additional prompt for training the LLM, wherein the additional prompt includes addition input data indicating a change from the select tab to one other tab, the instructions causing the addition input data to train the LLM to change one or more weightings to raise one or more ranking scores or raise one or more relevancy scores for the one other tab for subsequent prompts sent to the LLM.
